(19) United States
(12) Patent Application Publication
(10) Pub. No.: US 2017/0193883 A1
(43) Pub. Date: Jul. 6, 2017

(54) Non-illuminated hazardous material placard system with electronic paper technology

(71) Applicant: Gabor Pal, Riviera Beach, FL (US)

(72) Inventor: Gabor Pal, Riviera Beach, FL (US)

(21) Appl. No.: 14/986,721

(22) Filed: Jan. 3, 2016

(51) Int. Cl. G09G 3/20; G06F 3/0484; G06F 3/041; G06F 3/033; G09F 7/00; B60R 13/00

(52) U.S. Cl. CPC G09G 3/2092; G09F 7/00; B60R 13/00; G06F 3/041; G06F 3/033; G06F 3/04842; G09G 2380/06; G09G 2380/10; G09G 2330/00

(57) ABSTRACT

An E-paper hazardous placard system made up of non-illuminated colored placards for vehicles carrying hazardous materials. The colored placards are changed as desired on screen or using a remote control to signal different hazardous loads. The placards are based on display panels of electronic paper. There are at least four colored placards on each side of a vehicle to collectively identify the hazardous cargo being transported in compliance with federal regulations. The system requires power only when selecting images, not to maintain them, so there's no risk of losing the image and being in violation of federal regulations.

### BACKGROUND OF THE INVENTION

1. Field of the Invention

The present invention relates to a non-illuminated hazardous material placard system for commercial vehicles which can selectively display any one of a number of symbols on a placard, required by the U.S. Department of Transportation to be posted on the exterior of a commercial vehicle while hauling hazardous substances.

2. Description of Relevant Art

When a commercial vehicle is used to haul a hazardous material, a sign indicating the hazardous material is required to be placed on all four sides of the vehicle. The particular signs used for identifying hazardous materials are mandated by the U.S. Department of Transportation. These placards are in the form of a diamond shaped sign which identifies the substance and the nature of the hazard (i.e., radiation, fire or explosive, etc.) Whenever the contents of the vehicle are changed, however, a driver must change the hazardous materials signs present on the vehicle. To avoid the need for repeated changing of the hazardous materials signs, it is desirable to provide electronically controlled signs which can display any of the required hazardous materials signs.

The relevant art describes various means of including warning and advertising signs on particular vehicles, and will be discussed in the order of perceived relevance to the present invention.

U.S. Pat. No. 4,574,269 issued on Mar. 4, 1986, to Gregory R. Miller describes a visual communicator for a rear window of a vehicle. The message display unit is semi-transparent and includes a matrix of light emitting diodes energized by a message control unit. Selected words such as “PASS” and “THANKS” are shown on the message display unit. There is no suggestion to apply this unit to display signs with various colors and designs.

U.S. Pat. No. 4,094,083 issued on Jun. 13, 1978, to Harry Fund describes a vehicle placarding apparatus consisting of imprinted plates hinged to a diamond-shaped base and frame to show a single inscription for hazardous cargo, especially for roll-up rear doors of trailers. The first configuration has only two rectangular plates suitable only for a solid wall. The second configuration has four triangular plates, and is designed only for a roll-up door to fit over two adjacent door segments. These signs are fastened to the walls of the trailer and to the roll-up rear door. There is no suggestion for substituting an integral illuminated diamond for signifying hazardous cargo.

U.S. Pat. No. 4,974,354 issued on Dec. 4, 1990, to Norbert Hembrook, Jr., describes a visual display device for vehicles. A rectangular frame has multiple (five or more) translucent or transparent panels with each panel having cone shaped notches (uncolored) to form letters of a message such as “HELP”. The specific printed panel is illuminated from staggered light emitting diodes (LED) or incandescent light bulbs positioned in supports at the top and bottom edges of the rectangular sign. The conductor wires in the horizontal supports can optionally be replaced by a printed circuit board. The specific sign is selected and energized, respectively, by an electrical message control unit located in the cab and the vehicle battery. There is no suggestion for utilizing the LED's or incandescent light bulbs in a single plane for the cone-shaped notches. The present invention utilizes only one panel incorporating the versatility of posting multiple signs.

U.S. Pat. No. 5,450,058 issued on Sep. 12, 1995, to Stanton E. Collier describes a highway deployable directional hazard sign dispensable from the rear of a police vehicle to warn oncoming vehicles of a stopped vehicle. The impact warning device has an elevated light bar consisting of at least six lighting panels which are programmed to either point sequentially to the left or right with arrowheads at the end panels. A battery is provided in the device for energizing the lights and to sound a horn if the sign is impacted. There is no suggestion for either substituting lettered signs or for posting on the sides of a trailer.

U.S. Pat. No. 6,067,011 issued on May 23, 2000, to Darryl E. Leslie describes an electronic warning system made of illuminated LED or LCD technology. This system cannot be a possible substitute for current placards because of the thickness limitation, reflection in light, continuous power requirement and sensitivity to outside elements. There is no suggestion for providing placards by a non-illuminated solution, like electronic paper.

European Patent Application No. 0 537 882 A1 published on Apr. 21, 1993, for Courtney B. Bailey describes a mobile or stationary advertising sign having up to five large screens housed in a vehicle and having its own electricity generator and air conditioning system. Video projectors and speaker systems are provided for each translucent screen to create the advertisement. There is no suggestion for providing lettered signs by the use of LED's or the like.

U.S. Pat. No. 4,446,643 issued on May 8, 1984, to Shozo Fujita et al. describes a movable display sign housed in a trailer. The signs are created on lateral surfaces of the trailer by either monochromatic cathode ray tubes or colored light emitting tubes which create a heat build-up within the trailer. The solution is to include a plurality of air conditioners inside the trailer. There is no suggestion for substituting other illuminated devices.

None of the above inventions and patents, taken either singularly or in combination, is seen to describe the instant invention as claimed. Thus, a non-illuminated hazardous placard system with electronic paper technology solving the aforementioned problems is desired.

### SUMMARY OF THE INVENTION

The present invention includes a plurality of diamond-shaped non-illuminated electronic paper signs placed on all four sides of a vehicle and controlled onscreen and/or a remote control to display hazardous material images on demand.

The unit has stored in its memory every new placard of specified dimensions required by the U.S. Department of Transportation for vehicles carrying hazardous materials. There are at least 22 different standardized diamond-shaped signs with different warnings, symbols and colors. Since the driver must post the specific sign located on all four sides of the vehicle for the particular hazardous load, the selection is quickly made from either the remote control or onscreen. Thus, the present invention eliminates the tedious posting and changing of various placards. Furthermore, the present invention eliminates the expenses of maintaining a supply of all the necessary hazardous material placards and manually changing said placards.

It is the object of the invention to provide an on-demand hazardous material placard system that does not require power to maintain images, therefore eliminates the risk of losing the displayed image and become non-compliant with federal regulation.

It is the object of the invention to provide non-illuminated placards of every hazardous material required by the Department of Transportation.

It is a further object of the invention to provide non-illuminated signs from electronic paper flat display panels.

It is an object of the invention to provide improved elements and arrangements thereof in a non-illuminated hazardous placard system for the purposes described which is inexpensive, dependable and fully effective in accomplishing its intended purposes.

It is an object of the invention to provide a solution that withstands outside elements like extreme temperatures, precipitation or excessive sunlight.

It is an object of the invention to provide an on-demand display that has no reflection in light, so the images are always clear therefore comply with federal regulations.

These and other objects of the present invention will become readily apparent upon further review of the following specification and drawings.

### BRIEF DESCRIPTION OF THE DRAWINGS

FIG. 1 is a perspective view of a Non-illuminated hazardous material placard placed on one side of a commercial vehicle

FIG. 2 is a front view of a Non-illuminated hazardous material placard operated with touch-screen control

FIG. 3 is a front view of a Non-illuminated hazardous material placard operated with a remote control

FIG. 4 is a perspective view of a Non-illuminated hazardous material placard with an input for temporary power supply

FIG. 5 is a perspective view of a Non-illuminated hazardous material placard permanently connected to a commercial vehicle's power supply

### DETAILED DESCRIPTION

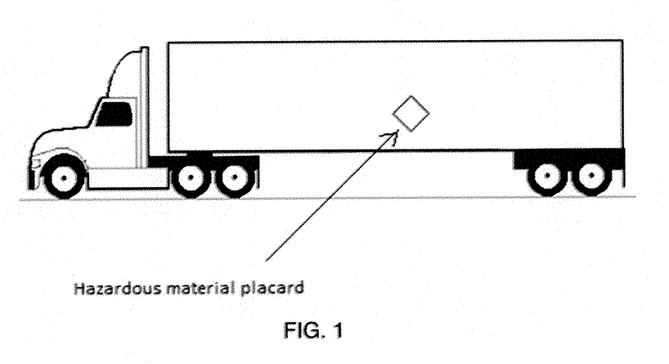

FIG. 1 is a perspective view of a Non-illuminated hazardous material placard placed on one side of a commercial vehicle. Federal regulations require placards to be placed on all four sides of a vehicle transporting hazardous material. The other three placards are not visible on the drawing.

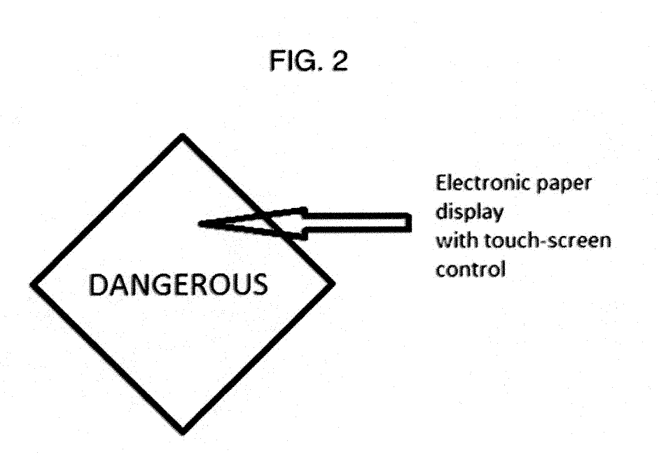

FIG. 2 shows a placard that can be controlled with a touchscreen display. Electronic paper displays have touchscreen capabilities that makes selecting the images very simple, with no need for additional devices for the system.

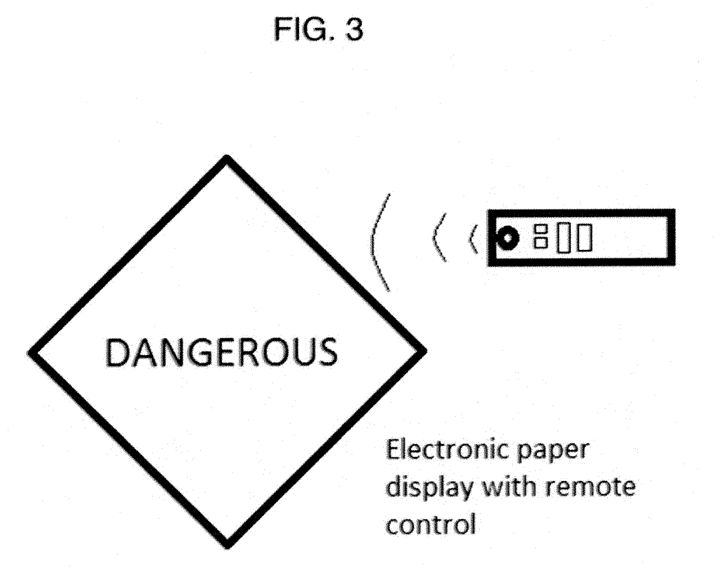

FIG. 3 shows a placard that is controlled with a remote control if it is preferred by the consumer. The images can be selected by the remote control on-screen, an advantage of this application, that the remote control could be used as a temporary power supply for the electronic paper display for the duration of selecting images, therefore eliminating the need for any other power supply.

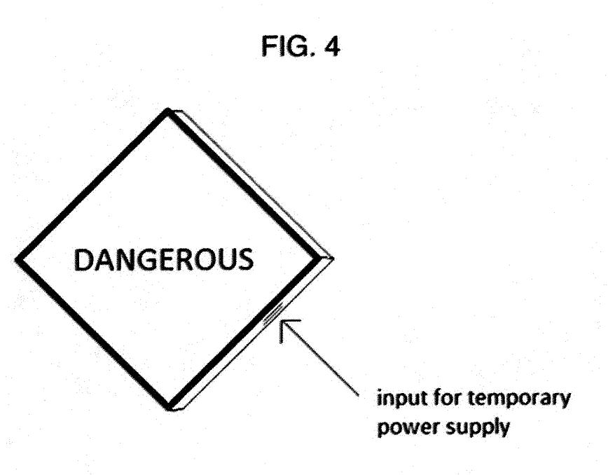

FIG. 4 shows a 3D view of a placard with an input on the body for temporary power supply to change images. This configuration is the first of the options for providing power for the duration of image selection. The power supply could be a simple battery, battery operated device or a remote control with the matching output connection.

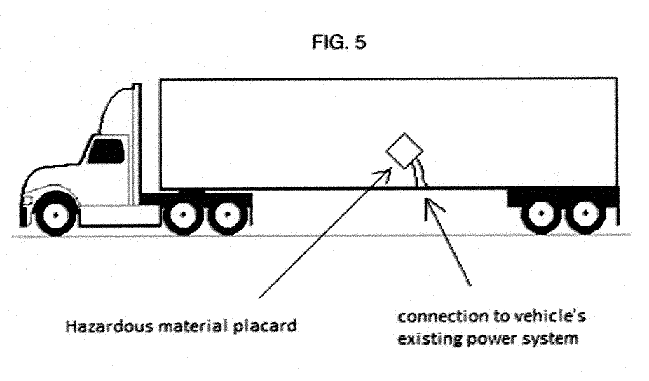

FIG. 5 is a perspective view of a Non-illuminated hazardous material placard permanently connected to a commercial vehicle's power supply. This configuration is the second of the options for providing power for the duration of image selection.

The detailed description is to be construed as exemplary only and does not describe every possible embodiment because describing every possible embodiment would be impractical, if not impossible. Numerous alternative embodiments could be implemented, using either current technology or technology developed after the filing date of this disclosure, which would still fall within the scope of the claims.

I claim:

1. A non-illuminated hazardous placard system for vehicles carrying hazardous materials comprising:
At least one diamond-shaped placard unit comprising a flat display panel being positioned on one of the four sides of a vehicle;
Placard unit being adapted to display a multi-colored hazardous material sign on demand;
Power source for the duration of selecting the required image;
Said power source can be connection to the vehicle's existing power system or independent source;
In case of not using touchscreen control a remote control unit to select required image.

2. The non-illuminated hazardous placard system according to claim 1. Said flat display panel being an electronic paper panel.

3. The non-illuminated hazardous placard system according to claim 1. Said flat display panel does not require power to maintain the displayed images

4. The non-illuminated hazardous placard system according to claim 1. Said flat display panel requires power to select the required images

5. The non-illuminated hazardous placard system according to claim 1. Said flat display panel has a size of at least 250 mm on all sides.

6. The non-illuminated hazardous placard system according to claim 1. Said display panel is mounted directly on vehicle or placed in existing placard holder.

7. The non-illuminated hazardous placard system according to claim 1. There being at least four diamond-shaped placard units, positioned one on each of the four sides of the vehicle.
